(19) United States
(12) Patent Application Publication
(10) Pub. No.: US 2019/0351294 A1
(43) Pub. Date: Nov. 21, 2019

(54) HIGH VISIBILITY LACROSSE BALL

(71) Applicant: Donald J. Klassen, Hudson, WI (US)

(72) Inventor: Donald J. Klassen, Hudson, WI (US)

(21) Appl. No.: 16/418,432

(22) Filed: May 21, 2019

Related U.S. Application Data
(60) Provisional application No. 62/745,584, filed on Oct. 15, 2018.
(60) Provisional application No. 62/674,246, filed on May 21, 2018.

(51) Int. Cl. A63B 37/12; B05D 3/10; B05D 1/02

(52) U.S. Cl. CPC A63B 37/12; A63B 2102/14; B05D 1/02; B05D 3/101

(57) ABSTRACT

A high visibility reflective lacrosse ball and related methods of forming the high visibility reflective lacrosse ball. The high visibility reflective lacrosse ball includes a high visibility exterior that is clearly distinguishable from a background environment and is easily picked up by both camera lenses and human eyesight. The high visibility lacrosse ball can include a plurality of spaced apart, retroreflective markers that reflect a directional beam of light toward a light source. The high visibility exterior can include an exterior coating or layer having a color selected as being highly visible and/or fluorescent. The retroreflective markers can be formed from a reflective adhesive film. The exterior coating can be cured such that the exterior coating is robust and resilient and is neither degraded nor removed during typical game play.

### RELATED APPLICATIONS

The present application claims priority to U.S. Provisional Application Serial Nos. 62/674,246 filed May 21, 2018 and 62/745,584 filed Oct. 15, 2018, both of which are incorporated by reference in their entirety.

### TECHNICAL FIELD

The present application is directed to balls used in the sport of lacrosse. More specifically, the present application is directed to high visibility lacrosse balls and related methods of increasing the visibility of lacrosse balls for both players, an in-person audience and a remote viewing audience.

### BACKGROUND

The sport of lacrosse is currently experiencing large growth rates across the United States. As the number of participants increase and the overall fan base of the game grows, more people are watching lacrosse games both in person and remotely via television, online streaming, or other media sources. Unfortunately, some of the inherent characteristics of the game can make the viewing experience less than desirable.

In the sport of lacrosse, a small ball is passed back and forth between teammates with the ultimate goal of putting this ball past a goalie and into an opposing team's net. For top level players, the speed at which the ball is passed between teammates and shot on goal can be as such high speeds that it can be difficult for fans to see and keep up with play. Additionally, players often hide the ball in the pocket of their lacrosse stick to sneak it into the goal net. The ability to catch glimpses of the ball while in the pocket of a player's lacrosse stick would be very enlightening to the viewing audience. The pockets of lacrosse sticks are made of netting, allowing a high visibility ball to show through. As such, it would be advantageous to improve the lacrosse ball such that both in-person and remote audiences are able to better view the lacrosse ball during game play.

### SUMMARY

The present invention is directed to lacrosse balls with a high visibility exterior that serve to clearly distinguish the ball from a background environment for easy tracking by both camera lenses and human eyesight. The high visibility exterior can comprise an exterior coating or layer having one or more colors selected as being highly visible and/or fluorescent. In some embodiments, the exterior coating can comprise two or more highly visible/fluorescent colors, for example, individual hemispheres in different colors or alternatively having strips, blocks, dot or other alternating patterns of different colors. The exterior coating is generally very thin so as to not impart any noticeable difference to the physical properties of the lacrosse ball, for example overall diameter or weight. In some embodiments, the exterior coating can exhibit an increased level of tackiness on an exterior surface of the lacrosse ball to increase handling properties of the lacrosse ball. In some embodiments, the exterior coating can be softer than an interior rubber core of the lacrosse ball to lower risk of injury. Following application of the exterior coating, the lacrosse ball can be cured such that the exterior coating is robust and resilient and is neither degraded nor removed during typical game play.

In one aspect of the present invention, a lacrosse ball generally comprises a high visibility exterior.

In another aspect of the present invention, a method of forming a high visibility lacrosse ball comprises applying an exterior coating having at least one color selected as having properties associated with high visibility and/or fluorescence.

In another aspect of the present invention, a system of viewing a high visibility lacrosse ball comprises using a ultraviolet radiation directed down to the playing field to increase visibility of the lacrosse ball by enhancing its brightness.

The present invention is further directed to lacrosse balls that comprise reflective properties and a system of using the reflective lacrosse ball to enhance both in person and remote viewing of the game of lacrosse. The reflective material is generally comprised of glass beads that are lined up on the surface of the material and applied to at least one portion of a lacrosse ball in such a manner as to maximize reflection and redirection of light from certain angles. Further, the reflective material is elastomeric, allowing it to conform to the ball during play. The balanced application of the reflective material minimizes the effect of the reflective material on the trajectory of the ball when it is being tossed. In some embodiments, the reflective material can be applied to the surface in a variety of shapes and sizes. The reflective material is generally very thin so as to not impart any noticeable difference to the physical properties of the lacrosse ball, for example overall diameter or weight. In some embodiments, the reflective film adhesive may be applied to the modified surface of a polyurethane lacrosse ball. The system of viewing the reflective lacrosse ball comprises using a high-powered light source, such as a spot light or high-intensity discharge lamp, or alternatively a plurality of floodlights that cover the field of play, to increase visibility of the reflective lacrosse ball. Generally, the light sources include a color filter, such as a red filter, resulting in the ball giving off a colored glow, increasing visibility. In some embodiments, the use of plain white light that is without a color filter may be preferred. In some embodiments the high powered light source may be connected to a video camera.

In one aspect of the present invention, a lacrosse ball generally comprises a reflective material exterior.

In another aspect of the present invention, a method of forming a high visibility lacrosse ball comprises applying a reflective material having properties associated with high visibility and/or reflection of light.

In another aspect of the present invention, a system of viewing a high visibility lacrosse ball comprises using a high powered light source, such as a spot light or high-intensity discharge lamp, and, in certain applications, a color filter to increase visibility of the lacrosse ball by reflecting light to the camera or live-action viewer.

In another aspect of the present invention, a lacrosse ball generally comprises a high visibility exterior including reflective material.

In another aspect of the present invention, a method of forming a high visibility lacrosse ball comprises applying both an exterior coating having at least one color selected as having properties associated with high visibility and/or fluorescence and a reflective material having properties associated with high visibility and/or reflection of light.

In another aspect of the present invention, a system of viewing a high visibility lacrosse ball including reflective material comprises using a high powered light source and, in certain applications, a color filter to increase visibility of the lacrosse ball by reflecting light to the camera or live-action viewer.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a plan view of a conventional lacrosse ball of the prior art alongside a high visibility lacrosse ball according to an embodiment of the present invention.

FIG. 2 is a section view of the high visibility lacrosse ball of FIG. 1 taken at line A-A of FIG. 1.

FIG. 3 is a flow chart illustrating a method of fabricating the high visibility lacrosse ball of FIG. 1 according to an embodiment of the present invention.

FIG. 4 is a partial sketch showing the system for improved viewing of the game of lacrosse of the present invention.

FIG. 5 is a flow chart illustrating a method of fabricating the enhanced reflective lacrosse ball of FIG. 4 according to an embodiment of the present invention.

FIG. 6 is a plan view of the enhanced highly visible lacrosse ball of FIG. 4 with a retroreflective material applied in a plurality of circles.

FIG. 7 is a plan view of a highly visible lacrosse ball with the Fluorescent red-orange Transfer film applied in a plurality of circles.

FIG. 8 is a plan view of a highly visible polyurethane lacrosse ball with an application of a plurality of Silver Transfer Film polka dots in combination with a plurality Fluorescent red-orange Transfer Film polka dots.

FIG. 9A is a chart illustrating lighting and visibility scenarios for an indoor lacrosse game.

FIG. 9B is a chart illustrating lighting and visibility scenarios for an indoor lacrosse game.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

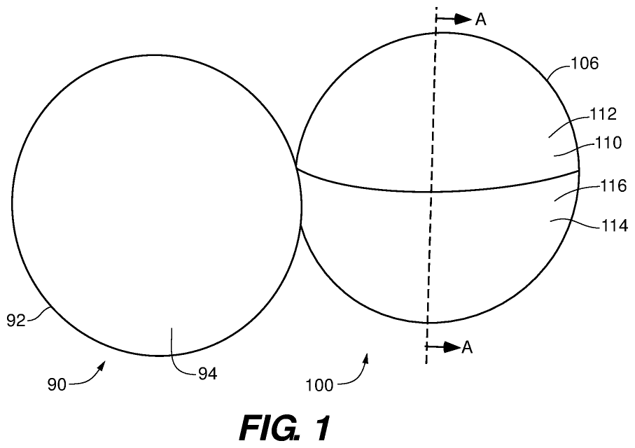

Referring to FIG. 1, a conventional lacrosse ball 90 of the prior art generally comprises a spherical body having an exterior surface 92 with a conventional color 94, for example, white. Conventional lacrosse ball 90 can comprise natural rubber or synthetic rubber such as, for example, a polyurethane material. Typically, the natural rubber comprises an isoprene polymer mixed with resins, pigments and fillers. The elastomeric nature of the isoprene polymer in combination with oils, pigments, resins and waxes that gradually exude to the exterior surface 92 tend to interfere with bonding and lead to the exterior surface 92 being resistant to adhesion with surface coatings.

Referring again to FIG. 1, a high visibility lacrosse ball 100 of the present invention generally comprises an exterior coating 106 or layer. As illustrated, exterior coating 106 generally comprises at least a first high visibility color 112, and can comprise additional high visibility colors, for example, a second high visibility color 116. As illustrated, the first high visibility color 112 and second high visibility color 116 can be selected as having fluorescent properties such as, for example, fluorescent yellow and orange. Additional colors such as, for example, fluorescent versions of pink, green and blue as well as other suitable colors can be utilized as well. Generally, the first high visibility color 112 and second high visibility color 116 can define different areas or patterns in the exterior coating 106, for example, a first hemisphere 110 and a second hemisphere 114 as shown in FIG. 1. Alternatively, the first high visibility color 112 and second high visibility color 116 can define other patterns or shapes such as, for example, stripes, blocks, dots and the like.

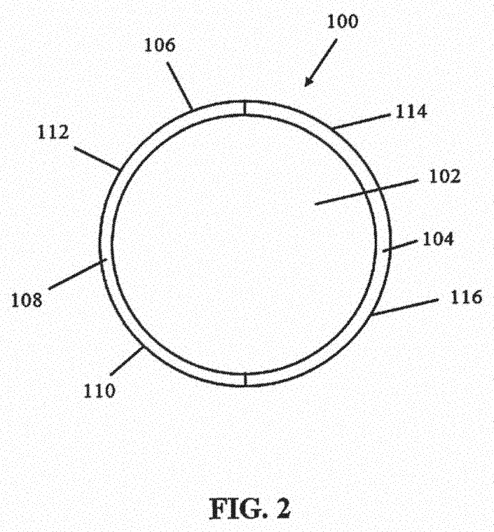

With reference to FIG. 2, high visibility lacrosse ball 100 generally comprises an interior ball 102 having a ball surface 104. The exterior coating 106 resides on the ball surface 104 and generally defines a exterior coating thickness 108. Exterior coating thickness 108 is kept to a minimum to avoid departing from the physical characteristics of the conventional ball 90 such as overall diameter, size and weight. In this way, high visibility lacrosse ball 100 can be substituted for conventional ball 90 without negatively impacting game play and still satisfy the standards of various lacrosse leagues and organizations. In some embodiments, exterior coating 106 can provide additional tackiness or grip over the exterior surface 92 of the conventional ball 90.

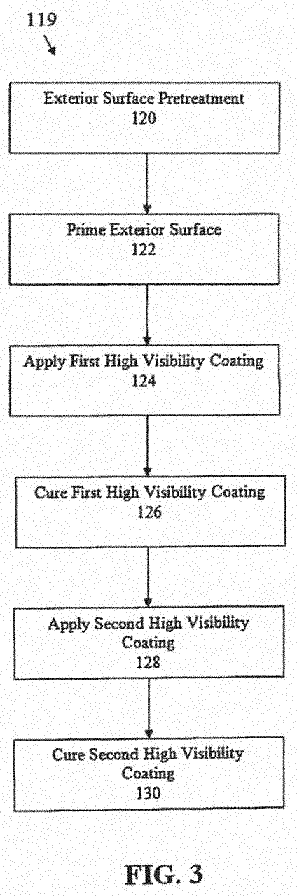

With reference to FIG. 3, an embodiment of a process 119 for forming the high visibility lacrosse ball 100 is illustrated schematically. Generally, process 119 starts with a pretreatment step 120 in which the ball surface 104 is cleaned to remove any surface contaminants, for example, dirt or materials that have exuded to the ball surface 104 such as, for example, oil, pigments, resins and waxes that can interfere with bonding. Generally, cleaning of the interior ball 102 should be accomplished so as to avoid transferring any oils from a hand to the ball surface 104. Preferably, a solvent such as, for example, mineral spirits is used to clean the ball surface 104. Following a complete cleaning of the entire ball surface 104, the interior ball 102 is placed on a clean, resin-free tissue to dry for a period of at least 10 minutes.

Once the interior ball 102 has dried, a priming step 122 is performed in which the ball surface 104 is prepared to accept the exterior coating 106. Generally, a suitable adhesive such as, for example, 80 Rubber & Vinyl Spray Adhesive available from 3M® Corporation of Maplewood, Minn. is evenly applied over the ball surface 104. Suitable adhesives will include properties that enhance quick and strong bonding between the exterior coating 106 and rubber ball surface 104. In the event that interior ball 102 includes a circumferential mold line, additional adhesive can be applied to the mold line to lessen any sharpness or visual impact of the mold line. Following an even application of the adhesive, the interior ball 102 is allowed to dry for a period of at least 10 minutes.

In another alternative priming step 122, priming can be performed in which the ball surface 104 is sprayed with a suitable primer such as, for example, white underlying Plasti Dip® brand paint, available from Plasti Dip International of Blaine, Minn., as a base coat while the paint and ball are warmed to around 90 degrees Fahrenheit. This alternative priming step 122 provides adequate adhesion with most natural rubber balls 100, but is not as universal as the previous embodiment. The base white color underneath the fluorescent color is used to brighten up the fluorescent outer color.

Following priming, a first coating application step 124 is performed by applying the first high visibility color 112 to the first hemisphere 110. First high visibility color 112 can comprise a rubber-based fluorescent paint in an aerosol form that is sprayed over the first hemisphere 110 such that the first hemisphere 110 has an even and full, wet coat applied. A suitable rubber-based paint can comprise Plasti Dip® brand paint available from Plasti Dip International of Blaine, Minn. In some embodiments, the interior ball 104 can be placed in a jig during the first coating application step 124. In the event that the interior ball 104 includes a circumferential mold line, the interior ball 102 can be positioned in the jig such that the circumferential mold line essentially defines the interface between the first hemisphere 110 and the second hemisphere 114, thus rendering the mold line as less visible and obtrusive.

Following first coating application step 124, a first curing step 126 is performed in which the first high visibility color 112 is allowed to cure for about 30 minutes. First curing step 126 can be performed at ambient conditions. Alternatively, first curing step 126 can be accomplished using a drying assembly having elevated temperatures.

Following the first curing step 126, a second coating application step 128 is performed by applying the second high visibility color 116 to the second hemisphere 114. Second high visibility color 116, with the exception of the different color, can comprise a rubber-based fluorescent paint in an aerosol form that is formulated similarly to first high visibility color. Second high visibility color 116, in an aerosol form, is sprayed over the second hemisphere 114 such that the second hemisphere 114 has an even and full, wet coat applied. During the second coating application step 128, the interior ball 102 can be rotated in the jig to allow for painting of the second hemisphere 114. Two coats of the final fluorescent colors are applied to make the application more uniform across the ball surface 104.

Following second coating application step 128, a second curing step 130 is performed in which the second high visibility color 116 is allowed to cure for about 30 minutes. Second curing step 130 can be performed at ambient conditions. Alternatively, second curing step 130 can be accomplished using a drying assembly having elevated temperatures.

Following second curing step 130, the formation of high visibility lacrosse ball 100 is complete. The first and second high visibility colors 112 and 116 combine to define the exterior coating 106 that is both highly visible and resistant to chipping or detachment from the ball surface 104. In some embodiments, the first and second high visibility colors 112 and 116 can be selected to impart additional grip or tackiness to the high visibility lacrosse ball 100 as compared to the conventional ball 90.

In one embodiment ultraviolet radiation may be directed down from above in the form of strips around the stadium to further enhance the brightness of the high visibility lacrosse ball 100. In another embodiment ultraviolet radiation may be directed down from the goal areas.

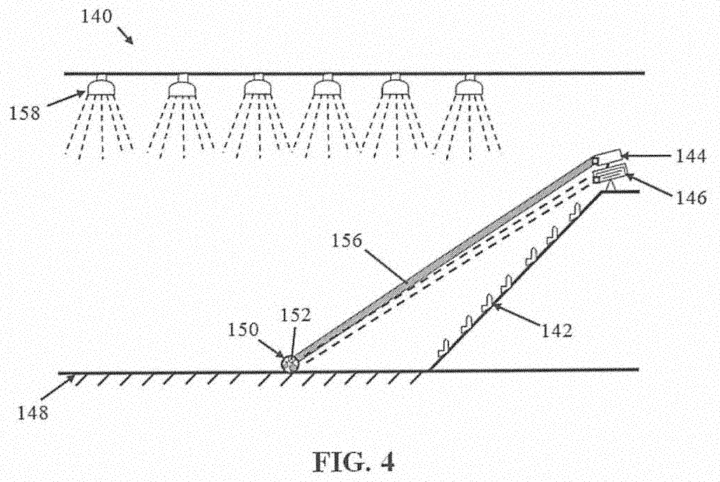

Referring now to FIG. 4, a conventional lacrosse stadium 140 generally comprises a plurality of audience seating 142 surrounding a playing field 148. Located on or in close proximity to the playing field 148 is an enhanced highly reflective lacrosse ball 150 that includes a retroreflective material 152 on a portion of the exterior surface of the enhanced highly reflective lacrosse ball 150. The enhanced highly reflective lacrosse ball 150 is followed by a video camera 146 to enable viewing of a lacrosse game by a remote audience through media devices, including but not limited to televisions, tablets, cellular phones, and computers.

Referring again to FIG. 4, a high powered light source 144, such as a spot light or high-intensity discharge lamp (HID lamp), is located proximal to, and preferably is physically and operably connected to, the video camera 146. In one embodiment, the high powered light source 144 can produce unfiltered white light or can include a color filter, such as a red filter. The high powered light source 144 shines directionally down onto the playing field 148 and is substantially in line with the tracking of video camera 146. During play, the high powered light source 144 follows and continuously produces a directional beam of light 156 that is directed at and onto the enhanced highly reflective lacrosse ball 150, thereby striking the retroreflective material 152. The directional beam of light 156 will then be reflected in the direction towards the high powered light source 144, resulting in the enhanced highly reflective lacrosse ball 150 being perceived by the video camera 146, and remote viewers, as shining white when no filter is used or shining a certain color when a color filter is used. The majority of the onsite audience in audience seating 142 will not be able to see the directional beam of light 156 or any color if a color filter is used. However, some of the onsite audience may see some flicker of the directional beam of light 156 reflect off the retroreflective material 152 on the enhanced highly reflective lacrosse ball 150. In embodiments the retroreflective material 152 is generally comprised of glass beads that are lined up on the surface of the retroreflective material 152 to be applied.

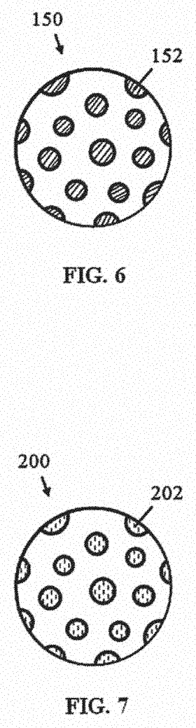

FIG. 6 shows a closer view of enhanced highly reflective lacrosse ball 150 with an application of the retroreflective material 152 in retroreflective markers comprising a plurality of circles in the form of polkadots having, for example, a half inch in diameter. Generally, the total surface area of the retroreflective markers is between about 5% to about 20% of the surface area of the enhanced highly reflective lacrosse ball 150. In a preferred embodiment, the total surface area of the retroreflective markers is about 15% of the surface area of the enhanced highly reflective lacrosse ball 150. The color of enhanced highly reflective lacrosse ball 150 does not matter. Preferably, it is desired to use the least number of retroreflective markers necessary to achieve a desired level of visibility enhancement as elite lacrosse players can begin to notice slight changes in ball handling for example, slipperiness, as more and more of the exterior surface is covered.

The shine or glow of the enhanced highly reflective lacrosse ball 150 is caused by the reflective material's narrow angularity properties of redirecting or reflecting the light back towards the light source with some rays of light forming into the shape of a cone. This process is similar to what an individual sees, for example, when looking at a highway sign at night while driving. In this example, the light is being reflected back into the automobile's headlights but the close angle between the driver and the headlights results in the reflected headlight beam also reaching the driver, thereby allowing the driver to benefit from the narrow angularity property of the reflective film on the highway sign.

In one embodiment, the high powered light source 144 may comprise at least one spot light or alternatively, at least one high-intensity discharge lamp. The center of the high powered light source 144 is aligned with the center of the focus of the video camera 146. The high powered light source 144 and the video camera 146 move in parallel during the course of play. Optimally, the high powered light source 144 is as close to the video camera 146 as possible without obstructing the view of the video camera 146. In embodiments the high powered light source 144 may comprise a white light using a colored filter of any color, such as red. Additionally, in certain embodiments the use of plain white light, which is without a color filter, may be preferred.

In yet other embodiments, the present invention may include replacing the high powered light source 144 with a plurality of flood lights 158 that cover the playing field 148, as shown in FIG. 4. Similar to the high powered light source 144, each of the flood lights may include a colored filter, such as a red color filter. The combination of the colored filter on flood lights 158 of the stadium and a similarly colored reflective adhesive film on the enhanced reflective lacrosse ball 150 will result in the ball showing up a with a bright colored glow and being more conspicuous. Additionally, this lighting setup could further increase the visibility of the enhanced highly reflective lacrosse ball 150 if the ball surface 104 is a red color, and more so if the ball surface 104 is a fluorescent red color. The fluorescent glow of the ball will not show up as bright when using the flood lights 158 as the flood lights 158 emit lower light intensity in the direction of the observed light than what is retroreflectively reflected off the ball surface 104 when the high powered light source 144 is used nearby the video camera 146. Additionally, the fluorescent glow will not be as bright indoors as outdoors because of the nature of ultraviolet light given off by the sun.

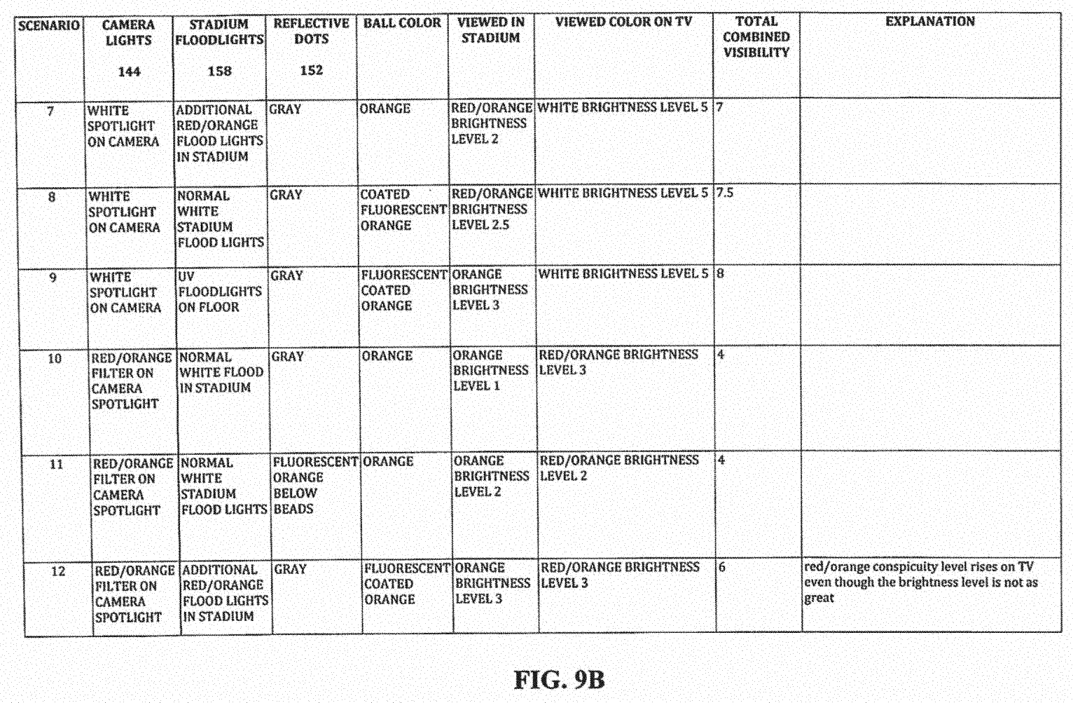

Referring to FIGS. 9A and 9B, various lighting conditions and corresponding visibility results are for indoor lacrosse games. Generally, the lighting conditions include variables such as camera lights (high powered light source 144), stadium floodlights (flood lights 158), reflective dots (retroreflective material 152) and ball color (conventional ball 90 (white/yellow/orange), conventional ball 90 with fluorescent orange pigment, high visibility lacrosse ball 100 coated in fluorescent orange). For the various conditions, visibility ratings were assigned on a 1 (least visible) to 5 (most visible) scale for both in-stadium viewers and well as remote television viewers. The in-stadium and remote television viewer ratings were then combined to provide a Total Combined Visibility rating.

Again referring to FIGS. 9A and 9B, conditions associated with a conventional indoor lacrosse game are listed in Scenario 1. In Scenarios 2 through 12, a variety of ball and lighting conditions were adjusted to achieve higher Total Combined Visibility scores. As seen in every one of Scenarios 2 through 12, the use of a high powered light source 144 and retroreflective material 152 results in an increased Total Combined Visibility scored as compared to conventional conditions. It is further seen that the use of a retroreflective material 152 with a gray base below the beads provides increased visibility as compared to a fluorescent orange base below the beads. Furthermore, it is possible to achieve visibility scores using a white spotlight for high powered light source 144 that are equivalent to visibility scores where the high powered light source is a UV floodlight without the potential harmful effects of the UV light. As such, Scenario 4 represents a preferred lighting arrangement for an indoor lacrosse game that is highly visible to both in-person and remote viewers.

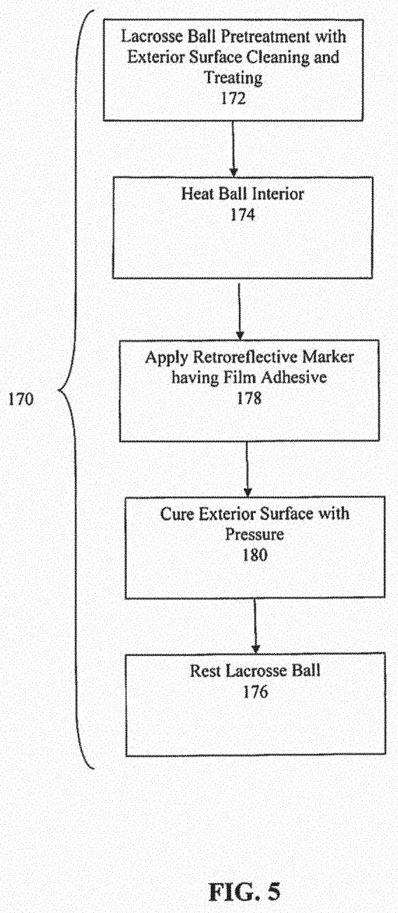

With reference to FIG. 5, an embodiment of a reflective film application process 170 for joining a reflective film adhesive to a natural rubber lacrosse ball 100 is illustrated schematically. Additionally, in other embodiments process 170 can be used to apply reflective film adhesive to polyurethane balls or potentially balls of other materials. Generally, process 170 starts with a surface cleaning and treating step 172 in which the ball surface 104 is cleaned to remove any surface contaminants, for example, dirt or materials that have exuded to the ball surface 104 such as, for example, oil, pigments, resins and waxes that can interfere with bonding. Generally, cleaning of the interior ball 102 should be accomplished so as to avoid transferring any oils from a hand to the ball surface 104. Surface cleaning and treating step 172 can utilize solvents selected for use with the ball material. Optimal solvents include mineral spirits for natural rubber lacrosse balls and lacquer thinner for polyurethane lacrosse balls. In some instances, the solvents and result in the formation of microscopically rough portions of the ball surface 104 while simultaneously cleaning the ball surface 104. These benefits are also experienced in embodiments using a polyurethane lacrosse ball. This can enhance adhesion properties on the ball surface 104. Following a complete cleaning of the entire ball surface 104, the natural rubber lacrosse ball 100 is dried. One drying method involves placing the interior ball 102 on a clean, resin-free tissue to dry for a period of at least 10 minutes.

Once the interior ball 102 has dried, a heating step 174 is performed in which the ball interior 102 is heated to about 130 degrees Fahrenheit. This ensures that the ball will remain at an elevated temperature as compared to ambient conditions during the subsequent application step.

Following the heating step 174, an application of a reflective film adhesive step 178 is performed in which a heat and pressure based application process is used. One may use a heat plate, heating rod, heat shaft, or other similar methods to apply the reflective adhesive to the lacrosse ball within an approximate temperature range of 300-360 degrees Fahrenheit, approximate pressure range of 10-30 psi, and a dwell time of approximately 20-30 seconds. For example, one may apply the film using a pressure plate at 300 degrees Fahrenheit and 5 PSI for about 25 seconds. The heat and pressure cause the reflective film adhesive to adequately flow into the rubber ball surface 104 to accomplish sufficient adhesion. Additionally, application of a reflective film adhesive step 178 provides the benefit of reflective film adhesion to the natural rubber lacrosse ball 100 while embossing or roughening the surface of the reflective film to reduce the lacrosse ball's slipperiness in the lacrosse player's basket.

Following the application of a reflective film adhesive step 178 the ball surface 104 is cured with pressure step 180. To cure the exterior ball surface 104 pressure is applied by squeezing down on the application for a few seconds, enabling the transfer film to embed in the ball surface. In some embodiments, the method 170 can comprise a further resting step 176 wherein the lacrosse ball 100 is allowed to rest at ambient conditions for at least 24, and more preferably at least 48 hours prior to use in a lacrosse game. This additional resting time ensures that the reflective adhesive and the ball material are completely bonded and can result in increased pull resistance and adhesion.

A suitable reflective film adhesive that may be used with the reflective film application process 170 on a natural rubber lacrosse ball 100 is 3M™ Scotchlite™ 8850 Silver Pressure Sensitive Adhesive Film which is composed of wide angle, exposed retroreflective lenses bonded to an adhesive. 3M™ Scotchlite™ 8850 Silver Pressure Sensitive Adhesive Film is manufactured by 3M Corporation located in Maplewood, Minn. In general, 3M™ Scotchlite™ 8850 Silver Pressure Sensitive Adhesive Film is a transfer film that has a rubber based pressure sensitive that is normally applied to at room temperature items such as for example rubber firemen's boots and coats that have a slick surface. When trying to apply 8850 to lacrosse balls at room temperature, it doesn't stick adequately as the ball surface is microscopically rough. Thus, the reflective film application process 170 and, in particular, the treatment with solvents step 176 using mineral spirits is highly beneficial. This reflective film application process 170 using the 3M™ Scotchlite™ 8850 Silver Pressure Sensitive Adhesive Film is successful with natural rubber lacrosse balls made by Signature Lacrosse located in Tampa, Fla., including Signature Lacrosse's Signature Branded Premium Balls as well as others.

Embodiments using the 3M™ Scotchlite™ 8850 Silver Pressure Sensitive Adhesive Film is one particular situation in which the use of a high powered light source 144 having a plain white light is actually preferred because the 8850 Silver Pressure Sensitive Adhesive Film comprises a white reflective color. In other embodiments other colored reflective film adhesive may be used. Any other colored reflective film adhesive has to be enclosed lens film as exposed lens film does not produce color from white light.

In an embodiment using an enhanced highly reflective lacrosse ball 150 having the 3M™ Scotchlite™ 8850 Silver Pressure Sensitive Adhesive Film thereon in conjunction with a white light based high powered light source 144 improves visibility of the ball to remote audiences. When the white light based high powered light source strikes the enhanced highly reflective lacrosse ball 150 and the retroreflective material 152 thereon, the light bounces back in the direction of the high powered light source 144, which will result in the enhanced high visibility lacrosse ball being perceived by the video camera 146 and viewers watching remotely as having a silver to silver-white glow or illuminated appearance on the ball.

It is noted that lacrosse balls are traditionally made of natural rubber which can be hardened by exposure to the sun's UV-rays and result in difficulty in play and increase in the potential for player injury even with player's padding due to the natural rubber lacrosse ball's 100 hardness and the speed at which the lacrosse ball moves during game play. Due to the potential hardening of the lacrosse ball resulting from the use of natural rubber, there is currently a strong movement to transition lacrosse balls from natural rubber to the more preferable polyurethane, which provides the advantage of being significantly more weather resistant while still meeting lacrosse league standards for playable balls.

Polyurethane is known as a long chain polymer, low surface energy material which the inventor has discovered has the ability to adhere to hot melt adhesive after one modifies the surfaces of the polyurethane with certain treatments of solvents. One such solvent, lacquer thinner, has been discovered to provide successful surface modification that enhances adhesion between the polyurethane surface and the reflective film adhesive.

In embodiments a variety of reflective film adhesives may be suitable for application onto a polyurethane ball. In one embodiment a suitable reflective film adhesive is 3M™ Scotchlite™ Reflective Material 8712 Silver Transfer Film, manufactured by 3M Corporation located in Maplewood, Minn. In general, 3M™ Scotchlite™ Reflective Material 8712 Silver Transfer Film is a wide angle, exposed retroreflective lenses bonded to the heat activated polyurethane. Reflective film application process 170 may be used to join the reflective film adhesive to the polyurethane ball using lacquer thinner as the solvent in treatment with solvents step 176.

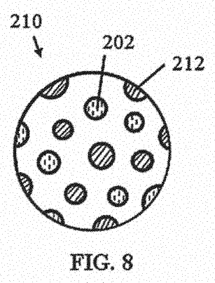

In one embodiment, a suitable reflective film adhesive that may be used on the polyurethane lacrosse ball is 3M™ Scotchlite™ Reflective Material 8786 Fluorescent red-orange Transfer Film, which is also manufactured by 3M corporation located in Maplewood, Minn. In general, 3M™ Scotchlite™ Reflective Material 8786 Fluorescent red-orange Transfer Film is a polyester adhesive composed of exposed high-performance glass lenses bonded to a durable polymer layer, which is coated with a heat-activated adhesive. FIG. 7 shows an enhanced reflective lacrosse ball 200 with an application of the Fluorescent red-orange Transfer Film 202 comprising a plurality of circles in the form of polkadots having, for example, a half inch in diameter. If the enhanced reflective lacrosse ball 200 is used in combination with a high powered light source 144 having a red light filter, striking the enhanced reflective lacrosse ball 200 and the Fluorescent red-orange Transfer Film 202 with the red light from the high powered light source 144 will result in the ball showing up with bright red/orange glow that can be seen by both on-site and remote viewers because the red/orange color of the Fluorescent red-orange Transfer Film will absorb all other visible colors of light.

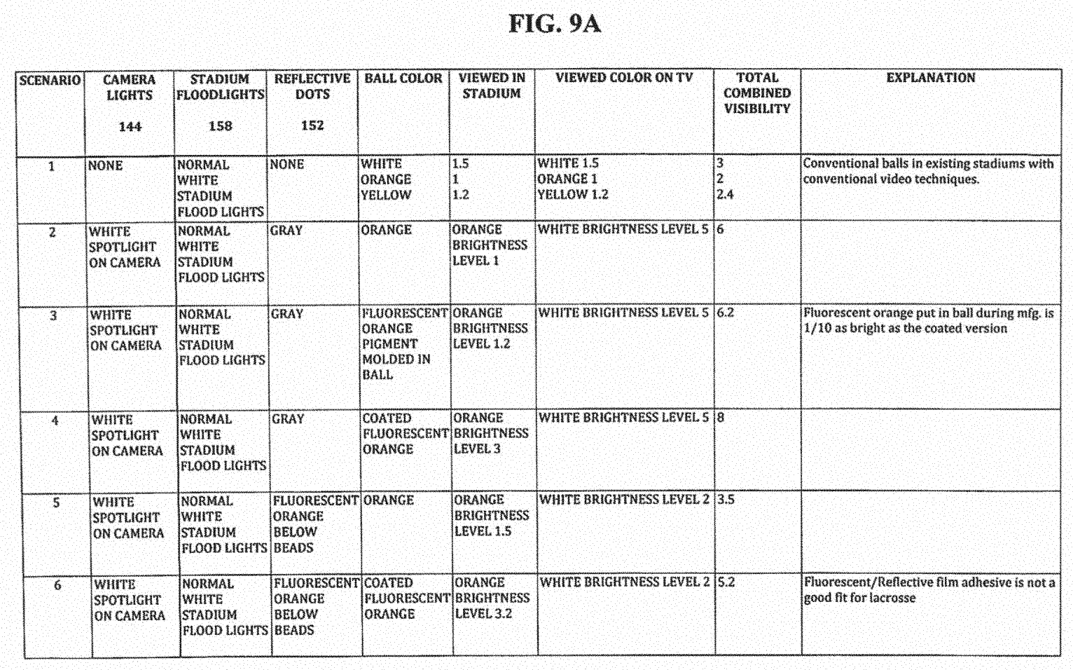

FIG. 8. shows an example of an application of the combination of a plurality of polka dot Silver Transfer Film 212 and a plurality of polka dot Fluorescent red-orange Transfer Film 202 applied to the modified surface of an enhanced reflective polyurethane lacrosse ball 210.

In embodiments, the reflective film adhesive may be applied to the modified surface of a lacrosse ball in a variety of shapes and sizes, including but not limited to stripes, triangles, rectangles, squares, narrow circumferential strips, and a one-piece wrap covering the entire exterior surface of the ball.

In embodiments, one of a variety of reflective films may be applied to a lacrosse ball including but not limited to exposed lens, enclosed lens, diamond grade, and high intensity grade.

In optimal embodiments, circular-shaped materials are preferred over other shaped materials due to stretching that occurs when one places a flat surface around a round surface. Considering this, having a circular shaped material applied to the ball instead of a square-shaped material, for example, optimizes the size of the material one wishes to apply to the ball because it reduces the likelihood for wrinkles and stretching.

In one embodiment players and/or live audience members may mount lights on their forehead to better see the reflective ball.

It is noted that other additions to the present invention may include but is not limited to the use of dimples in the ball, which would benefit in reducing the potential to peel out the reflective film and the use of a primer, thereby improving the adhesion of the reflective transfer films. In some embodiments, dimples can be created by using a lacrosse ball with dimples in it as a mother mold for thermosetting.

Importantly, process 119 for forming a high visibility lacrosse ball may be combined with process 170 for forming an enhanced highly reflective lacrosse ball to optimize visibility to both players and the audience. Further, the system and method of using high powered light source 144 or a plurality of flood lights 158 can be used in conjunction with this optimized ball to maximize visibility.

Various embodiments of systems, devices, and methods have been described herein.

These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A high visibility lacrosse ball comprising:
a spherical body having an exterior surface, wherein the exterior surface includes
a plurality of spaced apart, retroreflective markers, each marker formed of a reflective film that is selected to reflect a directional beam of light.

2. The high visibility lacrosse ball of claim 1, wherein the spherical body is made of natural rubber or polyurethane.

3. The high visibility lacrosse ball of claim 1, wherein the plurality of spaced apart, retroreflective markers include colored reflective film adapted to maximize a narrow angularity property for a certain color of light.

4. The high visibility lacrosse ball of claim 1, wherein the plurality of spaced apart, retroreflective markers include a perimeter shape selected from dots, stripes, triangles, rectangles, squares and narrow circumferential strips.

5. The high visibility lacrosse ball of claim 1, wherein the reflective film can be selected from an exposed lens film, an enclosed lens film, a diamond grade film, and a high intensity grade film.

6. The high visibility lacrosse ball of claim 1, further comprising an exterior coating of a unitary high visibility color having fluorescent properties, said plurality of spaced apart, retroreflective markers adhered to the exterior coating.

7. The high visibility lacrosse ball of claim 1, further comprising an exterior coating of at least two different high visibility colors, each of the at least two different high visibility colors having fluorescent properties and defining different areas of the exterior coating, said plurality of spaced apart, retroreflective markers adhered to the exterior coating.

8. The high visibility lacrosse ball of claim 1, wherein the plurality of spaced apart, retroreflective markers covers from about 5% to about 20% of the exterior surface.

9. A system for increasing visibility of a lacrosse ball, the system comprising:
the high visibility lacrosse ball of claim 1; and
a light source of the directional beam of light, wherein the light source is adapted to maximize the reflection of light from the reflective film of the retroreflective markers on the high visibility lacrosse ball.

10. The system of claim 9, wherein the light source is a high powered light source positioned to shine directionally downward on an area of play such as a spot light or high-intensity discharge lamp, shines directionally down onto the area of play.

11. The system of claim 10, wherein the high powered light source is physically mounted to a video camera that follows the high visibility lacrosse ball on the area of play.

12. The system of claim 10, wherein the high powered light source is a flood light.

13. The system of claim 10, wherein the high powered light source further comprises a color filter.

14. A method of adhering a plurality of spaced apart, retroreflective markers to a lacrosse ball, wherein the retroreflective markers are adapted to reflect a directional beam of light toward a source of the directional beam of light, the method comprising:
treating the lacrosse ball with an appropriate solvent to remove any surface contaminants or materials that have exuded or adhered to an exterior surface of the lacrosse ball;
heating the lacrosse ball to account for irregularities present on the exterior surface;
applying a reflective film adhesive using a heat and pressure process; and
curing the exterior surface of the lacrosse ball with pressure to facilitate the embedding of the reflective film into the lacrosse ball surface.

15. The method of claim 14, wherein the lacrosse ball comprises a natural rubber lacrosse ball and the appropriate solvent comprises mineral spirits.

16. The method of claim 14, wherein the lacrosse ball comprises a polyurethane lacrosse ball and the appropriate solvent comprises a lacquer thinner.

17. The method of claim 14, further comprising:
applying an exterior coating of high visibility color prior to the step of applying the reflective film adhesive.

18. The method of claim 17, wherein the step of applying the exterior coating of high visibility color comprises:
priming the lacrosse ball with an adhesive to facilitate acceptance of an exterior coating;
applying a coat of high visibility colored, rubber-based fluorescent paint in an aerosol form by evenly spraying over the lacrosse ball surface; and
curing the exterior surface of the lacrosse ball.

19. The method of claim 18, wherein the priming of the lacrosse ball is accomplished by evenly spraying a white base coat of rubber-based paint on the exterior surface of the lacrosse ball.

20. The method of claim 18, wherein applying a coat of high visibility colored, rubber-based fluorescent paint in aerosol form is accomplished by placing the lacrosse ball in a jig and by sequentially spraying each hemisphere of the lacrosse ball.

21. The method of claim 20, wherein each hemisphere is sequentially sprayed a different color of the high visibility colored, rubber-based fluorescent paint.

22. The method of claim 14, further comprising the step of:
resting the lacrosse ball for at least 24 hours following curing.
